(19) United States
(12) Patent Application Publication
(10) Pub. No.: US 2026/0022279 A1
(43) Pub. Date: Jan. 22, 2026

(54) LATEX COMPOUNDS WITH ENHANCED WATER BARRIER PROTECTION

(71) Applicant: Signal Engineering Consulting LLC, Emerson, GA (US)

(72) Inventor: Dennis Jones, JR., Emerson, GA (US)

(73) Assignee: Signal Engineering Consulting LLC, Emerson, GA (US)

(21) Appl. No.: 18/989,172

(22) Filed: Dec. 20, 2024

Related U.S. Application Data
(63) Continuation-in-part of application No. 18/932,769, filed on Oct. 31, 2024.
(60) Provisional application No. 63/674,036, filed on Jul. 22, 2024.

(51) Int. Cl. C09J 109/08; A47G 27/02; C09J 11/04; C09J 125/14

(52) U.S. Cl. CPC C09J 109/08; A47G 27/02; C09J 11/04; C09J 125/14

(57) ABSTRACT

A latex composition including an inorganic filler component and an elastomeric component is disclosed. The elastomeric component may include natural rubber and a synthetic polymer. The elastomeric component may include 5 to 35 parts of natural rubber to 65 to 95 parts of synthetic polymer. The latex composition may further include a crosslinking agent and one or more crosslinking auxiliaries configured to enhance a performance of the crosslinking agent in the latex composition.

### CROSS-REFERENCE TO RELATED APPLICATIONS

The present application is a continuation-in-part application of U.S. application Ser. No. 18/932,769, filed Oct. 31, 2024, which claims priority to and the benefit of U.S. provisional application No. 63/674,036, filed Jul. 22, 2024, which are hereby incorporated by reference herein in their entireties.

### TECHNICAL FIELD

The present disclosure relates to latex compounds or composition with enhanced water barrier protection, and more particularly to a latex composition that is applied to a broadloom or tufted carpet or an industrial carpet for enhancing the carpet's water barrier protection.

### BACKGROUND

Latex composition or compounds are used in various industries. For example, latex composition is commonly applied in floor covering applications or textile products, such as carpets or rugs. The latex composition is typically applied as a coating on a primary backing layer of a carpet, and as an adhesive on a secondary backing layer of a carpet. The latex coating on the primary backing layer helps to lock the fibers of the carpet onto the primary backing layer. Further, the adhesive latex composition on the secondary backing layer of the carpet facilitates in securely adhering the secondary backing layer to the primary backing layer (and additional layers, if present) of the carpet, thereby enhancing the overall carpet's strength and stability.

In the carpet industry, continuous efforts are being made to enhance various properties of the carpet, including the carpet's water barrier property. By enhancing the carpet's water barrier protection, the carpet manufacturers prevent fluid or water from leaking through the different layers of the carpet, thereby preventing the floor beneath the carpet from developing a stain or getting damaged.

A conventional method to enhance the carpet's water barrier protection includes adding a wax component or a thin polymeric water impermeable sheet between the different carpet layers described above. While the wax component or the water impermeable sheet is able to prevent water from leaking through the carpet layers, incorporating such components in the carpet may be expensive. Further, many-a-times, such components are able to prevent only a small amount of water from passing through (e.g., 10 or 20 ml), but may not prevent relatively larger water spills (e.g., 80 or 100 ml) from passing through.

In light of this, there is a need for a system that may effectively enhance a carpet's water barrier protection, without substantially increasing the cost of carpet manufacture.

It is with respect to these and other considerations that the disclosure made herein is presented.

### BRIEF DESCRIPTION OF THE DRAWING

The detailed description is set forth with reference to the accompanying drawing. Various embodiments may utilize elements and/or components other than those illustrated in the drawing, and some elements and/or components may not be present in various embodiments. Elements and/or components in the FIGURE are not necessarily drawn to scale. Throughout this disclosure, depending on the context, singular and plural terminology may be used interchangeably.

FIG. 1 depicts different layers of a carpet in accordance with the present disclosure.

### DETAILED DESCRIPTION

### Overview

The present disclosure describes a latex composition that may be applied to one or more layers of a textile product, e.g., a carpet or a rug, to enhance the textile product's fluid/water barrier properties. Specifically, the latex composition may prevent water from passing through the textile product (e.g., the carpet) when a user or a pet spills the water on the carpet, thereby protecting the surface/floor beneath the carpet from getting stained or damaged.

In some aspects, a carpet manufacturer may apply the latex composition, as described in the present disclosure, to a primary backing layer and/or a secondary backing layer of the carpet. The carpet manufacturer may apply the latex composition to the primary backing layer as a precoat application, and to the secondary backing layer as an adhesive application. In some aspects, the percent solids of the latex composition may be least 50, preferably in a range of 75 to 85. The latex composition may include a plurality of components, as described below.

The latex composition may include an inorganic filler component and an elastomeric component. In an exemplary aspect, the inorganic filler component may include calcium carbonate. The inorganic filler component may be present in the latex composition in an amount of at least 50 weight percent, preferably in a range of 75 to 90 weight percent. In an exemplary aspect, the inorganic filler component may be present in the latex composition in an amount of 150 to 625 dry parts per 100 dry parts of elastomeric component.

The elastomeric component may include natural rubber and a polymer based on styrene acrylate or styrene butadiene. In some aspects, the elastomeric component includes 3 to 15 parts of natural rubber to 85 to 97 parts of polymer. In an exemplary aspect, the elastomeric component includes 5 to 15 parts of natural rubber to 85 to 95 parts of polymer when the polymer is synthetic styrene-butadiene (SBR). Further, the elastomeric component includes 3 to 12 parts of natural rubber to 88 to 97 parts of polymer when the polymer is synthetic styrene acrylate. In an exemplary aspect, the elastomeric component is present in the latex composition in a range of 10 to 20 weight percent.

The latex composition may include one or more additional components. For example, the latex composition may include a surfactant component, which may be, for example, an anionic surfactant, a cationic surfactant, a non-ionic surfactant, alkoxy moieties, and/or the like. In some aspects, the surfactant component may be present in the latex composition in a range of 0.1 to 1 weight percent. Further, the surfactant component may be present in the latex composition in an amount of 1 to 10 dry parts per 100 dry parts of elastomeric component.

The latex composition may further include a thickener and a crosslinking agent. In an exemplary aspect, the crosslinking agent may be sulfur powder. Further, the thickener may be present in the latex composition in an amount of 0.5-3 dry parts per 100 dry parts of elastomeric component.

In some aspects, for “difficult to treat textile products” or scenarios where the desired performance level of textile products with regard to liquid barrier performance is high, the latex composition may include a higher ratio of natural rubber to synthetic polymer in the elastomeric component than the ratio described above. Examples of “difficult to treat textile products” may include those textile products that use face fibers that are repellent to liquids (polypropylene, for example), face fibers that are pretreated with liquid repellent compounds prior to coating or backing, textile products or greige constructions that are lower overall in face weight, and/or the like.

In this case, the latex composition may include elastomeric component that has 5 to 35 dry parts of natural rubber to 65 to 95 dry parts of synthetic polymer (which may be based on styrene acrylate or styrene butadiene). To make such a high ratio of natural rubber to synthetic polymer effective in the latex composition, the role of the crosslinking agent (e.g., sulfur powder) is important. Specifically, the cross linking density is an important factor for the latex composition to effectively have a higher ratio of natural rubber to synthetic polymer, and hence for the latex composition to exhibit enhanced liquid barrier performance.

In some aspects, in this case, the latex composition may further include one or more crosslinking auxiliaries or accelerators that may enhance the performance of the crosslinking agent in the latex composition. Specifically, the effectiveness or efficiency of the crosslinking agent (sulfur powder) can be optimized through the use of crosslinking auxiliaries or accelerators. The use of the crosslinking auxiliaries or accelerators allows for optimization/reduction of the sulfur level in the latex composition, and also reduces the time and temperature required for adequate cross linking. In an exemplary aspect, the crosslinking auxiliaries or accelerators may be or include zinc oxide (specifically Zinc oxide 40%) and/or zinc dibutyldithiocarbamate.

In some aspects, the amounts of crosslinking agent (e.g., sulfur powder) and the crosslinking auxiliaries in the latex composition may be based on an amount of natural rubber in the elastomeric component. Such a latex composition, as described above, not only enables the textile product to pass the British spill test, but also enables the textile product to perform exceedingly well in more stringent tests (e.g., AATCC 42 Water Resistance/moisture impact test).

The present disclosure discloses a latex composition that enhances the carpet's water or fluid barrier properties or the carpet's water barrier protection, without increasing (or substantially increasing) the cost of carpet manufacture. Further, the latex composition makes the carpet less flammable, even when the carpet includes one or more environment-friendly cellulose based backing layers.

These and other advantages of the present disclosure are provided in detail herein.

### Illustrative Embodiments

The disclosure will be described more fully hereinafter with reference to the accompanying drawing, in which example embodiments of the disclosure are shown, and not intended to be limiting.

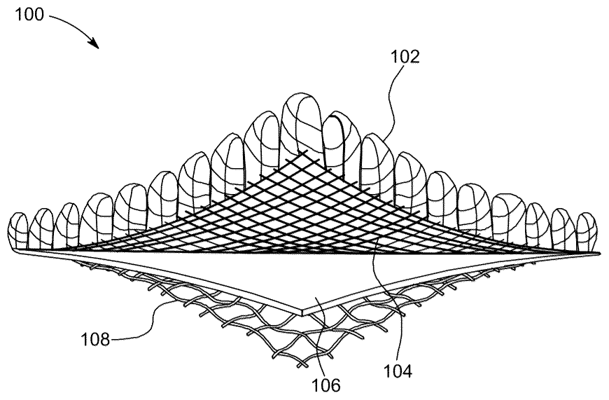

The present disclosure discloses a latex composition or a latex compound that may be applied to one or more layers of a textile product, e.g., a rug or a carpet (e.g., a carpet 100 shown in FIG. 1 and described later in the description below). Hereinafter, the textile product is referred to as carpet 100.

The latex composition, as described in the present disclosure, enhances the carpet's water or fluid barrier properties or the carpet's water barrier protection, without increasing (or substantially increasing) the cost of carpet manufacture. Stated another way, the latex composition, as described in the present disclosure, prevents water (or any other fluid) from passing through the carpet 100 without making the carpet 100 expensive. Enhanced water barrier protection ensures that the floor beneath the carpet 100 is not damaged when a user or a pet inadvertently spills water (or any other fluid) on the carpet 100. As an example, the latex composition may ensure that soft drinks, Koolaid, pet urine, and/or any other type of aqueous based solution, which can create stain on the carpet fibers, carpet substrates, and/or the floor beneath the carpet, do not penetrate through the carpet.

In addition, the latex composition, as described in the present disclosure, makes the carpet 100 less flammable, even when the carpet 100 includes one or more environment-friendly cellulose based backing layers. Specifically, the carpet 100 passes the ASTM D2859 or the methenamine pill test when the latex composition, as described in the present disclosure, is applied to one or more carpet's layers. Examples of such layers include, but are not limited to, primary and/or secondary backing layers. Details of carpet's primary and secondary backing layers are described later in the description below.

It may be appreciated that jute fibers have historically being used in woven construction as the carpet's primary and secondary backing layers; however, their usage is limited due to their flammable properties. Since the barrier effect of the latex composition described in the present disclosure retards the passage of both fluids and atmosphere through the backing layers, the carpet manufacturers may use jute fibers or other flame prone fibers (such as natural cellulosic materials (cotton for example, which is more environment-friendly)) as carpet face fibers, as well as primary and secondary backing layers, which, up to this point have not been employed for broadloom carpets.

Furthermore, it may be appreciated that currently Poly trimethyl terephthalate (PTT) polymer is used to a limited degree for carpets, which provides good stain resistance and a very soft hand. However, PTT is prone to pill test failures, so alumina containing filler (ATH, alumina trihydrate) is typically incorporated as part of the inorganic filler system for the carpet. The latex composition, as described in the present disclosure, offers the possibility of reducing the amount of the expensive ATH in the compound, while also providing enhanced water barrier properties.

In some aspects, the percent solids of the latex composition, as described in the present disclosure, is at least 50. In an exemplary aspect, the percent solids of the latex composition is in a range of 75 to 85. The latex composition includes an inorganic filler component and an elastomeric component. In some aspects, the elastomeric component is present in the latex composition in a range of 10 to 20 weight percent, and the inorganic filler component is present in the latex composition in an amount of at least 50 weight percent. In an exemplary aspect, the inorganic filler component is present in the latex composition in an amount of 75 to 90 weight percent. In a preferred aspect, the inorganic filler component is present in the latex composition in an amount of 150 to 625 dry parts per 100 dry parts of elastomeric component. In other aspects, the inorganic filler component is present in the latex composition in an amount of 200 to 800 dry parts per 100 dry parts of elastomeric component.

The amount and percentage of the inorganic filler component used in a given latex composition/compound may be optimized according to the desired water barrier properties/performance criteria for the carpet 100. In some aspects, the inorganic filler component includes calcium carbonate. In further aspects, the inorganic filler component may include silica, alumina, talc, or clay or various mixtures thereof.

The elastomeric component includes natural rubber and a polymer (e.g., a synthetic polymer) based on styrene acrylate or styrene butadiene. In some aspects, the elastomeric component includes polyisoprene (natural rubber, cis-1,4-polyisoprene) and polymer based on 1,3 dienes and/or polymer based on styrene acrylate. For example, the elastomeric component may include one or more of styrene-1,3-butdiene (SBR), styrene-1,3-butadiene terpolymer with an unsaturated carboxylic acid (carboxylated SBR), acrylonitrile-1,3-butadiene (NBR or nitrile rubber), isobutylene-isoprene (butyl rubber) and block copolymers of isoprene or 1,3-butadiene with styrene. Polyisoprene and polymers based on 1,3 dienes, for example, may be present in any desired ration. In some embodiments, polyisoprene and polymer based on 1,3 dienes may be present in a 1:8 ratio. As another example, elastomeric polymers of styrene acrylic may be present in the elastomeric component.

In some aspects, the elastomeric component includes 3 to 15 parts of natural rubber to 85 to 97 parts of polymer that includes synthetic styrene butadiene or synthetic styrene acrylate. Specifically, in a preferred embodiment, the elastomeric component includes 5 to 15 parts of natural rubber to 85 to 95 parts of polymer when the polymer is synthetic styrene-butadiene (SBR). Further, the elastomeric component includes 3 to 12 parts of natural rubber to 88 to 97 parts of polymer when the polymer is synthetic styrene acrylate. The ratios of natural rubber to the synthetic polymer, as described herein, are optimal ratios that have been derived from experiments/tests to deliver enhanced water barrier properties for the carpet 100. The details of the experiments/tests are described later in the description below. In further aspects, the elastomeric component may include 5 to 35 parts of natural rubber to 65 to 95 parts of the polymer based on synthetic styrene butadiene or synthetic styrene acrylate, depending on the desired water barrier properties for the carpet 100 as described later in the description below.

In some aspects, the elastomeric component described above is crosslinked. Crosslinking of the elastomeric component may be achieved with any suitable crosslinking system. In an exemplary aspect, sulfur powder may be added to the elastomeric component/latex composition as a crosslinking agent. Stated another way, the latex composition, as described in the present disclosure, may include a crosslinking agent that may be sulfur powder. The crosslinking agent may effectively crosslink (or “join”) the molecules of the natural rubber and the synthetic polymer described above, thereby making the bonding in the latex composition more durable. It has been found through experimentation that enhanced crosslinking in the latex composition greatly enhances the water barrier properties of the carpet 100 in which the latex composition is applied. To enhance the performance of the crosslinking agent (or to make sure that the crosslinking between the natural rubber and the synthetic polymer is enhanced), the latex composition, as described in the present disclosure, may further include one or more crosslinking auxiliaries or accelerators that may enhance the performance of the crosslinking agent in the latex composition. Examples of such crosslinking auxiliaries are described later in the description below.

In some aspects, the latex composition may include one or more additional components. For example, the latex composition may further include a surfactant component. The surfactant component may include an anionic surfactant, a cationic surfactant, a non-ionic surfactant or various mixtures thereof. In some aspects, a suitable surfactant component may include a plurality of alkoxy moieties. For example, the surfactant component may include sulfate having a chain including alkoxy moieties. A non-limiting example of such a surfactant component is sodium laureth sulfate (SLES).

The surfactant component may be present in the latex composition in any desired amount. In some aspects, the surfactant component is present in the latex composition in a range of 0.1 to 1 weight percent. In an exemplary aspect, the surfactant component is present in the latex composition in a range of 0.3 to 0.7 weight percent. In further aspects, the surfactant component is present in the latex composition in an amount of 1 to 10 dry parts per 100 dry parts of elastomeric component.

The surfactant component is used in the latex composition to make the composition/compound easier to froth. In an exemplary aspect, the carpet manufacturer may limit the amount of surfactant used in the latex composition to just what is required for proper frothing, since the surfactant can interfere with both the ultimate strength of the latex composition and its water barrier performance.

The latex composition may further include a thickener. The thickener may be added to the latex composition to achieve a desired viscosity. In some aspects, the latex composition may exhibit a viscosity of at least 6,000 centipoise (cps). In an exemplary aspect, the latex composition exhibits a viscosity in a range of 8,000 to 30,000 cps. When the latex composition is frothed, the viscosity may be in a range of 15,000 to 35,000 cps.

In some aspects, the thickener is present in the latex composition in an amount of 0.5-3 dry parts per 100 dry parts of elastomeric component. A suitable thickener may be a polymeric material, such as polyacrylic acid, and may generally have 15% solids. In some aspects, the thickener component and the surfactant component are adjusted in the latex composition so that the density and viscosity of the frothed latex composition/compound are in a desired range, typically a higher range than is normally used for coating of conventional carpet products (carpets without water barrier properties). For the thickener amount, it has been found from experiments/tests that higher froth viscosity is a positive with regard to the water or aqueous based liquid penetration barrier effect.

As described above, the latex composition may be applied to one or more layers of the carpet 100. As depicted in FIG. 1, the carpet 100 may include a plurality of components or layers including, but not limited to, a plurality of fibers 102, a primary backing layer 104, a latex coat 106 (made of the latex composition described above), a secondary backing layer 108, and/or the like. In some aspects, the fibers 102 may be in the form of a yarn, and may include a polyamide, an olefin, a polyester, and/or the like. In some aspects, the primary backing layer 104 and/or the secondary backing layer 108 may be woven products, made from polypropylene or jute. In further aspects, the primary backing layer 104 and/or the secondary backing layer 108 may be non-woven products, made from, e.g., polypropylene polymer.

The primary backing layer 104 may include a primary front surface and a primary back surface that may be disposed opposite to the primary front surface. The primary back surface may face the latex coat 106 or the secondary backing layer 108. In some aspects, the fibers 102 may be disposed or located on (or inserted into) the primary front surface. Further, the secondary backing layer 108 may include a secondary front surface and a secondary back surface disposed opposite to the secondary front surface. In some aspects, the secondary front surface may face and be adhered to the primary back surface via the latex coat 106, and the secondary back surface may face the ground surface when the carpet 100 is placed on the ground. The secondary backing layer 108 enhances the carpet's dimensional stability.

In some aspects, the primary backing layer 104 and/or the secondary backing layer 108 may act as “substrates” on which the latex composition described above may be applied to enhance the carpet's water barrier protection and reduce the carpet's flammability. Since the carpet's flammability is reduced by coating/applying the latex composition to the substrate(s), the substrates may include cellulose-based products, which are environment-friendly (but may be flammable). Stated another way, a carpet manufacturer may use environment-friendly, cellulose-based substrates in the carpet 100 without increasing the carpet's flammability when the carpet manufacturer coats/applies the latex composition, as described in the present disclosure, to the carpet's substrate(s). The cellulose-based products, which may be used in the carpet's substrates, may include various paper products including, but not limited to, paperboard. The primary and secondary backing layers 104, 108 may be woven or non-woven products.

In some aspects, the carpet manufacturer may apply the latex composition between the primary back surface and the secondary front surface to enable attachment between the primary back surface and the secondary front surface. Once applied, the latex composition may prevent water (or any other fluid) to pass through the primary backing layer 104 and the secondary backing layer 108. Example methods of applying the latex composition on the substrates are described below.

In some aspects, the latex composition is applied as a precoat application to the primary back surface or the primary backing layer 104. In this case, the carpet manufacturer may pass the latex composition through a froth machine, and into a puddle/roller applicator where the frothed latex compound/composition is rolled/smoothed onto the primary back surface. The manufacturer controls the air content in the frothed latex compound/composition (and/or the applicator gap for the roller) such that the total amount of latex compound/composition added to the carpet per unit area is controlled. Typical precoat application for the primary backing layer 104 ranges from 14 ounces per square yard to up to as high as 38 ounces per square yard, of dried latex compound, depending on the type of carpet product being produced, and the desired performance characteristics. In an exemplary aspect, the latex composition as precoat application is present in an amount of about 15 to about 35 ounces per square yard of carpet 100/primary backing layer 104. Further, in an exemplary aspect, when the latex composition is used as a precoat application on the primary backing layer 104, the inorganic filler may be present in an amount of approximately 500 dry parts per 100 dry parts of elastomeric component.

The typical precoat application, applied to the primary back surface, is applied as a foam. The surfactant is needed for the precoat application, to produce the foam.

In further aspects, the latex composition is applied as an adhesive compound to the secondary front surface or the secondary backing layer 108. In this case, the carpet manufacturer may feed, in an un-frothed state, the latex composition into a pan/roller applicator where the viscous latex compound/composition adheres to a degree to the application roller, which, in turn, transfers the adhesive compound/latex composition to the secondary front surface as the secondary front surface moves by and contacts the surface of the roller. In some aspects, the carpet manufacturer may use modern design of the pan/roller applicator, generally referred to as a “Tillitson applicator”. The Tillitson applicator uses a higher viscosity setting for the adhesive compound and can apply a more precise and even coating of the adhesive compound to the secondary backing layer 108, as compared to a conventional pan/roller applicator system.

Typical adhesive latex compound application for the secondary backing layer 108 ranges from 5 ounces per square yard to as much as 10 ounces per square yard, of dried compound, depending on the specific carpet product and the desired performance characteristics.

In an exemplary aspect, the latex composition as adhesive compound is present in an amount of about 10 ounces (or less) per square yard of carpet 100/secondary backing layer 108. Further, in an exemplary aspect, when the latex composition is used as an adhesive compound on the secondary backing layer 108, the inorganic filler may be present in an amount of approximately 425 dry parts per 100 dry parts of elastomeric component.

The typical adhesive latex compound, applied to the secondary front surface, is not foamed. Therefore, no surfactant is required for the adhesive coat latex. The adhesive is applied at a reasonably low viscosity, as a liquid, using a transfer roller applicator.

The Tillitson applied adhesive is applied to the secondary front surface again, as a liquid, but at a much higher viscosity as compared to the transfer roller applicator.

A plurality of experiments/tests were conducted to identify an optimal ratio of natural rubber to SBR or styrene acrylate in the elastomeric component to provide enhanced water barrier protection to the carpet 100. The details of the tests are described and illustrated in the tables provided below.

A total wet weight of 500 grams was used for each example latex compound/composition. The sequence that was followed to add the various components to the latex composition is as follows: Synthetic latex compound (SBR latex or Styrene Acrylic latex); H2O, as required to meet the total solids target; Natural rubber latex; Inorganic filler, e.g., calcium carbonate powder; Surfactant; Sulfur powder (when required as a crosslinking agent); and Thickener.

After mixing using an overhead mixer, the compound was added to a Hobart mixing apparatus for frothing. Setting 2 for the mixer was used for 20 seconds, followed by setting 10 for 40 seconds. After frothing, the cup weight and froth viscosity of each compound was measured and recorded. The frothed compound was then applied to the primary back surface/primary backing layer 104, using conventional methods available for lab samples. The weight was controlled to 32 ounces per square yard of dried compound for each example.

The coated carpet sample was then dried at 275 degrees F., for eight minutes, in a flow through lab oven. The sample was then removed from the oven and allowed to cool and condition at standard conditions for 24 hours prior to testing. The carpet material used for each example was a 58 ounce per square yard cut pile construction using solution dyed PET yarn.

The British spill test was used to evaluate the water barrier performance of the carpet samples/examples. The basics of the test are that a 100 ml portion of an aqueous stain solution is spilled onto the carpet from a height of one meter. The carpet sample is then allowed to stand with the spill still present, for 24 hours, at this point, the carpet sample is lifted and the toweling placed underneath, prior to testing, is examined for any evidence of the stain solution. A passing grade results if there is no indication of any of the stain solution passing through the carpet product. In order to obtain more resolution for the water barrier testing, a range of stain solution amounts were employed (10 ml through 120 ml), for the British Spill testing conditions.

Table 1 below illustrates the test results when the elastomeric component included SBR based compounds at 425 parts filler loading (i.e., 425 parts of inorganic filler to 100 parts of elastomeric component).

| | | Comparative | Inventive | Inventive | Inventive | Inventive | Inventive |
|---|---|---|---|---|---|---|---|
| Formulas - | Solids | Ex. | Example | Example | Example | Example | Example |
| Dry Parts | (%) | 1 | 2 | 3 | 4 | 5 | 6 |
| Filler | 100 | 425 | 425 | 425 | 425 | 425 | 425 |
| H2O | 0 | as | as req | as req | as req | as req | as req |
| | | required | | | | | |
| Natural | 61 | | 20 | 15 | 10 | 5 | 3 |
| Rubber | | | | | | | |
| Latex | | | | | | | |
| SBR - | 52.5 | 100 | 80 | 85 | 90 | 95 | 97 |
| DL825A | | | | | | | |
| SA - | 56 | | | | | | |
| TB8303 | | | | | | | |
| SLES | 30 | 0.8 | 0.8 | 0.8 | 0.8 | 0.8 | 0.8 |
| Chemthick | 15 | 0.7 | 0.7 | 0.7 | 0.7 | 0.7 | 0.7 |
| 2015 | | | | | | | |
| Sulfur | 100 | | 0.12 | 0.12 | 0.12 | 0.12 | 0.12 |
| Powder | | | | | | | |
| Compound | | 81 | 81 | 81 | 81 | 81 | 81 |
| Solids % | | | | | | | |
| Compound | | 20000 | 19500 | 19200 | 19800 | 20500 | 19000 |
| Viscosity- | | | | | | | |
| Froth | | 21500 | 21200 | 21000 | 21600 | 21500 | 20500 |
| viscosity - | | | | | | | |
| cps | | | | | | | |
| 3 oz cup | | 115 | 110 | 105 | 112 | 117 | 106 |
| weight - g | | | | | | | |
| 1 meter | | Pass | Pass | Pass | Pass | Pass | Pass |
| spill - 10 | | | | | | | |
| ml | | | | | | | |
| 1 meter | | Pass | Pass | Pass | Pass | Pass | Pass |
| spill - 20 | | | | | | | |
| ml | | | | | | | |
| 1 meter | | Fail | Pass | Pass | Pass | Pass | Pass |
| spill - 30 | | | | | | | |
| ml | | | | | | | |
| 1 meter | | Not | Pass | Pass | Pass | Pass | Pass |
| spill - 60 | | tested | | | | | |
| ml | | (NT) | | | | | |
| 1 meter | | NT | Pass | Pass | Pass | Pass | Pass |
| spill - 80 | | | | | | | |
| ml | | | | | | | |
| 1 meter | | NT | Fail | Pass | Pass | Pass | Pass |
| spill - 100 | | | | | | | |
| ml | | | | | | | |
| 1 meter | | NT | NT | Fail | Pass | Fail | Fail |
| spill - 120 | | | | | | | |
| ml | | | | | | | |

As is illustrated by Table 1 above, the inclusion of a relatively small amount of natural rubber latex, in place of a portion of the synthetic SBR latex, greatly improves the water barrier effect (inventive examples 2-6 as compared to example 1). Further, as apparent from Table 1 provided above, in the case of the SBR synthetic latex, at 425 parts inorganic filler loading, it appears that a ratio of 90 parts of SBR to 10 parts of natural rubber latex is optimum for water barrier performance (Example 4). Further, it may be appreciated from the results shown in Table 1 that increasing the ratio of natural rubber latex does not necessarily increases the carpet's water barrier effect/protection. Therefore, an optimal ratio of natural rubber latex to SBR is required to be added to the elastomeric component to obtain “best” water barrier effect/protection for the carpet.

Table 2 below illustrates the test results when the elastomeric component included SBR based compounds at 500 parts filler loading (i.e., 500 parts of inorganic filler to 100 parts of elastomeric component).

| | Solids | Comparative | Inventive | Inventive |
|---|---|---|---|---|
| Formulas - Dry Parts | % | Example 1 | Example 7 | Example 8 |
| Filler | 100 | 425 | 500 | 500 |
| H2O | 0 | as req | as req | as req |
| Natural Rubber Latex | 61 | | 10 | 10 |
| SBR - DL825A | 52.5 | 100 | 90 | 90 |
| SA - TB8303 | 56 | | | |
| SLES | 30 | 0.8 | 0.55 | 0.55 |
| Chemthick 2015 | 15 | 0.7 | 0.83 | 0.82 |
| Sulfur Powder | 100 | 0.12 | 0.12 | |
| Compound Solids % | | 81 | 81 | 81 |
| Compound Viscosity - | | 20000 | 21000 | 12500 |
| cps | | | | |
| Froth viscosity - cps | | 21500 | 22000 | 13000 |
| 3 oz cup weight - g | | 115 | 121 | 127 |
| 1 meter spill - 10 ml | | Pass | Pass | Pass |
| 1 meter spill - 20 ml | | Pass | Pass | Pass |
| 1 Meter spill - 30 ml | | Fail | Pass | Pass |
| 1 meter spill - 60 ml | | NT | Pass | Pass |
| 1 meter spill - 80 ml | | NT | Pass | Pass |
| 1 meter spill - 100 ml | | NT | Pass | Pass |
| 1 meter spill - 120 ml | | NT | Pass | Pass |

Examples 7 and 8 of Table 2 illustrate that the ratio of 90 parts SBR latex with 10 parts natural rubber latex provides excellent water barrier performance, even at the increased filler loading of 500 parts. The comparison also illustrates that the presence of sulfur powder as a cross linking agent may not be required to achieve the water barrier performance.

Table 3 below illustrates the test results when the elastomeric component included Styrene Acrylate based compounds at 425 parts filler loading (i.e., 425 parts of inorganic filler to 100 parts of elastomeric component).

| | Sol- | Comparative | Inventive | Inventive | Inventive |
|---|---|---|---|---|---|
| Formula Dry | ids | Exam- | Exam- | Exam- | Exam- |
| Parts | % | ple 9 | ple 10 | ple 11 | ple 12 |
| Filler | 100 | 425 | 425 | 425 | 425 |
| H2O | 0 | as req | as req | as req | as req |
| Natural | 61 | 0 | 1 | 3 | 5 |
| Rubber Latex | | | | | |
| SBR - | 52.5 | | | | |
| DL825A | | | | | |
| SA - TB8303 | 56 | 100 | 99 | 97 | 95 |
| SLES | 30 | 0.4 | 0.8 | 0.8 | 0.3 |
| Chemthick | 15 | 2 | 2 | 2 | 2 |
| 2015 | | | | | |
| Sulfur Powder | 100 | | 0.12 | 0.12 | 0.12 |
| Compound | | 81 | 80 | 80 | 80 |
| Solids % | | | | | |
| Compound | | | | | |
| Viscosity- | | | | | |
| Froth | | 23500 | 19000 | 20000 | 20200 |
| viscosity - cps | | | | | |
| 3 oz cup | | 94 | 96 | 90 | 91 |
| weight - g | | | | | |
| 1 Meter spill - | | Pass | Pass | Pass | Pass |
| 10 ml | | | | | |
| 1 Meter spill - | | Pass | Pass | Pass | Pass |
| 20 ml | | | | | |
| 1 Meter spill - | | Pass | Pass | Pass | Pass |
| 30 ml | | | | | |
| 1 meter spill - | | Pass | Pass | Pass | Pass |
| 60 ml | | | | | |
| 1 meter spill - | | Fail | Pass | Pass | Pass |
| 80 ml | | | | | |
| 1 meter spill - | | NT | Pass | Pass | Pass |
| 100 ml | | | | | |
| 1 meter spill - | | NT | Fail | Fail | Pass |
| 120 ml | | | | | |

The examples in Table 3 above illustrate that excellent water barrier performance can be achieved with a ratio of 95 parts of styrene acrylate latex in combination with 5 parts of natural rubber latex, at 425 parts filler loading.

Table 4 below illustrates the test results when the elastomeric component included Styrene Acrylate based compounds at 500 parts filler loading (i.e., 500 parts of inorganic filler to 100 parts of elastomeric component).

| | solids | Comparative | Inventive | Inventive |
|---|---|---|---|---|
| Formula Dry Parts | % | Example 9 | Example 13 | Example 14 |
| Filler | 100 | 425 | 500 | 500 |
| H2O | 0 | as required | as required | as required |
| Natural Rubber | 61 | 0 | 7 | 7 |
| Latex | | | | |
| SBR - DL825A | 52.5 | | | |
| SA - TB8303 | 56 | 100 | 93 | 93 |
| SLES | 30 | 0.4 | 0.3 | 0.3 |
| Chemthick 2015 | 15 | 2 | 2.2 | 2.2 |
| Sulfur Powder | 100 | | 0.12 | |
| Compound Solids | | 81 | 80 | 80 |
| % | | | | |
| Compound | | | | |
| Viscosity- | | | | |
| Froth viscosity - | | 23500 | 25500 | 26000 |
| cps | | | | |
| 3 oz cup weight - | | 94 | 95 | 96 |
| g | | | | |
| 1 Meter spill - 10 | | Pass | Pass | Pass |
| ml | | | | |
| 1 Meter spill - 20 | | Pass | Pass | Pass |
| ml | | | | |
| 1 Meter spill - 30 | | Pass | Pass | Pass |
| ml | | | | |
| 1 meter spill - 60 | | Pass | Pass | Pass |
| ml | | | | |
| 1 meter spill - 80 | | Fail | Pass | Pass |
| ml | | | | |
| 1 meter spill - 100 | | NT | Pass | Pass |
| ml | | | | |
| 1 meter spill - 120 | | NT | Pass | Pass |
| ml | | | | |

The above examples in Table 4 illustrate that a combination of 93 parts of styrene acrylate latex with 7 parts of natural rubber latex provides excellent water barrier performance at 500 parts filler loading.

It is found through experimentation that the ratios of natural rubber to synthetic polymer (based on styrene acrylate or styrene butadiene), as described above, enable the carpet 100 to exhibit satisfactory water barrier performance (e.g., the carpet 100 clears the British spill test). In this case, the carpet 100 is constructed with face fibers that are highly absorbent with respect to liquids (nylon or cotton, for example). Further, in this case, the fiber face weights are on the higher end of the spectrum. In such cases, creation of liquid barrier by using the latex composition (as described above) is less challenging, and hence the ratios of natural rubber to synthetic polymer in the elastomeric component described above exhibit satisfactory performance.

However, more difficult to treat textile products (e.g., industrial carpets) may require higher ratios of natural rubber to synthetic polymer in the latex composition to provide satisfactory water barrier performance. Further, such textile products may be required to clear more stringent tests, in addition to the British spill test described above. For example, such textile products may be required to perform well on AATCC moisture impact test (or AATCC 42 Water Resistance test). It may be appreciated that the AATCC 42 Water Resistance test measures the resistance of fabrics to the penetration of water by impact, and is measured by “cycles” of impact before the fabric allows the water to penetrate through.

Examples of “difficult to treat textile products”, as described above, may include those textile products that use face fibers that are repellent to liquids (polypropylene, for example), face fibers that are pretreated with liquid repellent compounds prior to coating or backing, textile products or greige constructions that are lower overall in face weight, and/or the like.

It has been found through experimentation that by increasing the ratio of natural rubber to synthetic polymer in the latex composition, the water barrier performance of textile products (e.g., “difficult to treat textile products”) can be greatly enhanced, thereby enabling the textile product to perform exceedingly well in stringent tests such as AATCC 42 Water Resistance/moisture impact test. The higher ratio of natural rubber to synthetic polymer in the latex composition not only works effectively in “difficult to treat textile products”, but is also useful in scenarios where the desired performance level of textile products with regard to liquid barrier performance is high. The use of higher ratio of natural rubber to synthetic polymer in the latex composition also has the benefit of producing a latex backing that is more flexible and able to withstand more stress/repeated impacts, and is thus more durable over time.

In some aspects, the latex composition that provides enhanced liquid barrier performance in textile products (e.g., in the carpet 100), such that the textile products perform well in the AATCC 42 Water Resistance/moisture impact test, includes the elastomeric component that has 5 to 35 dry parts of natural rubber to 65 to 95 dry parts of synthetic polymer (which may be based on styrene acrylate or styrene butadiene).

To make such a high ratio of natural rubber to synthetic polymer effective in the latex composition, the role of the crosslinking agent (e.g., sulfur powder) is important. Specifically, the cross linking density is an important factor for the latex composition to effectively have a higher ratio of natural rubber to synthetic polymer, and hence for the latex composition to exhibit enhanced liquid barrier performance. In some aspects, an amount of crosslinking agent (sulfur powder) in the latex composition may be based on an amount of natural rubber in the elastomeric component. In an exemplary aspect, the crosslinking agent in the latex composition may be present in an amount of 1-6% of the amount of natural rubber dry parts in the elastomeric component. The experimentations have shown that the liquid barrier performance of the latex composition (and hence the textile product) is greatly enhanced when the crosslinking agent (sulfur powder) is present in an amount closer to 6% of the amount of natural rubber in the elastomeric component.

In some aspects, the latex composition may further include one or more crosslinking auxiliaries or accelerators that may enhance the performance of the crosslinking agent in the latex composition. Specifically, the effectiveness or efficiency of the crosslinking agent (sulfur powder) can be optimized through the use of crosslinking auxiliaries or accelerators. The use of the crosslinking auxiliaries or accelerators allows for optimization/reduction of the sulfur level in the latex composition, and also reduces the time and temperature required for adequate cross linking.

In some aspects, an amount of crosslinking auxiliaries in the latex composition is based on an amount of natural rubber in the elastomeric component. Further, in some aspects, the crosslinking auxiliaries may include at least one of zinc oxide (specifically Zinc oxide 40%) or zinc dibutyldithiocarbamate. In other aspects, the crosslinking auxiliaries may include both zinc oxide and zinc dibutyldithiocarbamate.

In an exemplary aspect, zinc oxide is present in the latex composition in an amount of 1-5% of the amount of natural rubber dry parts in the elastomeric component. Similarly, zinc dibutyldithiocarbamate is present in the latex composition in an amount of 1-5% of the amount of natural rubber dry parts in the elastomeric component. In further aspects, zinc oxide and/or zinc dibutyldithiocarbamate may be present in an amount that is based on the amount of crosslinking agent (sulfur powder) in the latex composition.

It has been observed from experimentation that for “easy to treat” textile products or greige materials (e.g., residential carpets), as far as British spill test performance goes, low levels of ratios of natural rubber to synthetic polymer (e.g., a ratio of 15 natural rubber dry parts to 85 synthetic polymer dry parts) and use of more economical styrene butadiene (SBR) based synthetic polymer can be employed. Cross linking in the latex composition for these products/materials may not be critical for performance in these cases. However, for the more difficult to treat textile products or greige materials, and/or carpet products targeted for higher levels of liquid barrier performance, it is advantageous to use styrene acrylate (SA) based synthetic polymer, in place of SBR. Furthermore, the cross linking systems including the crosslinking agent and the crosslinking auxiliaries, as described above, are more critical in these cases, and should be employed and optimized. In addition, for higher quality carpets/textile products, the filler loading in the latex composition has to be reduced.

A test was conducted to identify an optimal ratio of natural rubber to SBR or styrene acrylate in the elastomeric component to provide enhanced water barrier protection to the “difficult to treat textile products” or the textile products that are require greater level of water barrier protection. The details of the test are illustrated in Table 5 provided below.

| Crosslinking | | Inventive | Inventive | Inventive | Inventive | Inventive |
|---|---|---|---|---|---|---|
| Systems | Solids | Example | Example | Example | Example | Example |
| Test | (%) | 2 | 2A | 2B | 2C | 2D |
| Filler | 100 | 425 | 425 | 425 | 425 | 180 |
| H2O | 0 | as | as req | as req | as req | as req |
| | | required | | | | |
| Natural Rubber Latex | 61 | 20 | 20 | 35 | 35 | 12 |
| SBR - DL825A | 52.5 | 80 | 80 | 65 | | |
| SA - TB8303 | 56 | | | | 65 | 88 |
| SLES | 30 | 0.8 | 0.8 | 0.8 | 0.8 | 0.8 |
| Chemthick 2015 | 15 | 0.7 | 0.7 | 0.7 | 2.2 | 2.2 |
| Sulfur Powder | 100 | 0.12 | 1.2 | 2.1 | 2.1 | 0.42 |
| Zinc Oxide 40% | 40 | | 0.7 | 1.225 | 1.225 | 0.3 |
| Zinc | 55 | | 0.6 | 1.05 | 1.05 | 0.42 |
| dibutyldithiocarbamate | | | | | | |
| Compound Solids % | | 81 | 82 | 82 | 82 | 77 |
| Compound Viscosity- | | | | | | |
| Froth viscosity - cps | | 21200 | 21000 | 20700 | 24500 | 29000 |
| 3 oz cup weight - g | | 110 | 110 | 105 | 95 | 95 |
| 1 meter spill - 10 ml | | Pass | Pass | Pass | Pass | Pass |
| 1 meter spill - 20 ml | | Pass | Pass | Pass | Pass | Pass |
| 1 meter spill - 30 ml | | Pass | Pass | Pass | Pass | Pass |
| 1 meter spill - 60 ml | | Pass | Pass | Pass | Pass | Pass |
| 1 meter spill - 80 ml | | Pass | Pass | Pass | Pass | Pass |
| 1 meter spill - 100 ml | | Fail | Pass | Pass | Pass | Pass |
| 1 meter spill - 120 ml | | NT | Fail | Pass | Pass | Pass |
| AATCC 42 Moisture | cycles | 1800 | 2750 | 3500 | 5750 | 10000 |
| Impact | | | | | | |

The examples in Table 5 above illustrate that excellent water barrier performance can be achieved when SA is used in the latex composition as the synthetic polymer, and the ratio of natural rubber to synthetic polymer is 12:88 (as shown in Example 2D). Further, in this case, the filler loading is 180 dry parts to 100 dry parts of elastomeric component. Furthermore, the amount of Sulfur powder in this case is 3.5% of the amount of natural rubber, the amount of Zinc Oxide is 2.5% of the amount of natural rubber, and Zinc dibutyldithiocarbamate is 3.5% of the amount of natural rubber. This combination in the latex composition enables the textile product to withstand 10,000 cycles in the AATCC 42 Moisture Impact test, and pass the British spill test for 1 meter spill at 120 ml.

In another example (shown as Example 2C above in Table 5), the ratio of natural rubber to synthetic polymer (SA) is 35:65. Further, in this case, the filler loading is 425 dry parts to 100 dry parts of elastomeric component. Furthermore, the amount of Sulfur powder in this case is 6% of the amount of natural rubber, the amount of Zinc Oxide is 3.5% of the amount of natural rubber, and Zinc dibutyldithiocarbamate is 3% of the amount of natural rubber. This combination in the latex composition enables the textile product to withstand 5,750 cycles in the AATCC 42 Moisture Impact test, and pass the British spill test for 1 meter spill at 120 ml.

Further examples using SBR as the synthetic polymer are depicted in Table 5 above, which yields relatively lower performance on the AATCC 42 Moisture Impact test; however, still enables the textile product to clear the British spill test for 1 meter spill at 100 ml.

Although the description above is described in the context of a latex composition that may be applied to the substrates of the carpet 100, the present disclosure is not limited to such an aspect. In additional aspects, the latex composition, as described in the present disclosure, may also be applied to cardboard boxes to enhance their water barrier properties. For example, the latex composition may be applied to pizza boxes to prevent water or any other fluid from penetrating into the box.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A latex composition comprising:
an inorganic filler component;
an elastomeric component comprising natural rubber and a synthetic polymer, wherein the elastomeric component comprises 5 to 35 parts of natural rubber to 65 to 95 parts of the synthetic polymer;
a crosslinking agent; and
one or more crosslinking auxiliaries configured to enhance a performance of the crosslinking agent in the latex composition.

2. The latex composition of claim 1, wherein the crosslinking agent comprises sulfur powder.

3. The latex composition of claim 1, wherein an amount of crosslinking agent in the latex composition is based on an amount of natural rubber in the elastomeric component.

4. The latex composition of claim 3, wherein the crosslinking agent in the latex composition is present in an amount of 1-6% of the amount of natural rubber dry parts in the elastomeric component.

5. The latex composition of claim 1, wherein the one or more crosslinking auxiliaries comprise at least one of zinc oxide or zinc dibutyldithiocarbamate.

6. The latex composition of claim 5, wherein the zinc oxide in the latex composition is present in an amount of 1-5% of the amount of natural rubber dry parts in the elastomeric component.

7. The latex composition of claim 5, wherein the zinc dibutyldithiocarbamate in the latex composition is present in an amount of 1-5% of the amount of natural rubber dry parts in the elastomeric component.

8. The latex composition of claim 1, wherein an amount of crosslinking auxiliaries in the latex composition is based on an amount of natural rubber in the elastomeric component.

9. The latex composition of claim 1, wherein the one or more crosslinking auxiliaries comprise zinc oxide and zinc dibutyldithiocarbamate.

10. The latex composition of claim 1, wherein the synthetic polymer is based on styrene acrylate.

11. The latex composition of claim 1, wherein the synthetic polymer is based on styrene butadiene.

12. The latex composition of claim 1, wherein the inorganic filler component comprises calcium carbonate.

13. The latex composition of claim 1, wherein the inorganic filler component is present in the latex composition in an amount of 150 to 625 dry parts per 100 dry parts of the elastomeric component.

14. The latex composition of claim 1 further comprising a thickener, wherein the thickener is present in the latex composition in an amount of 0.5-3 dry parts per 100 dry parts of the elastomeric component.

15. The latex composition of claim 1, wherein the latex composition is applied to a substrate of a carpet, and wherein the latex composition is configured to prevent fluid to pass through the carpet.

16. The latex composition of claim 15, wherein the substrate is a primary backing layer or a second backing layer of the carpet.

17. A latex composition comprising:
an inorganic filler component;
an elastomeric component comprising natural rubber and a synthetic polymer, wherein the elastomeric component comprises 5 to 35 parts of natural rubber to 65 to 95 parts of the synthetic polymer, and wherein the synthetic polymer is based on styrene acrylate;
a crosslinking agent; and
one or more crosslinking auxiliaries configured to enhance a performance of the crosslinking agent in the latex composition, wherein the one or more crosslinking auxiliaries comprise at least one of zinc oxide or zinc dibutyldithiocarbamate.

18. The latex composition of claim 17, wherein an amount of crosslinking agent in the latex composition is based on an amount of natural rubber in the elastomeric component.

19. The latex composition of claim 17, wherein an amount of crosslinking auxiliaries in the latex composition is based on an amount of natural rubber in the elastomeric component.

20. A textile product comprising:
a primary backing layer comprising a primary front surface and a primary back surface, wherein a plurality of fibers is disposed on the primary front surface;
a secondary backing layer comprising a secondary front surface and a secondary back surface, wherein the secondary front surface is adhered to the primary back surface; and
a latex composition applied between the primary back surface and the secondary front surface to enable attachment between the primary back surface and the secondary front surface, wherein the latex composition is configured to prevent fluid to pass through the primary backing layer and the secondary backing layer, and wherein the latex composition comprises:
an inorganic filler component;
an elastomeric component comprising natural rubber and a synthetic polymer, wherein the elastomeric component comprises 5 to 35 parts of natural rubber to 65 to 95 parts of the synthetic polymer;
a crosslinking agent; and
one or more crosslinking auxiliaries configured to enhance a performance of the crosslinking agent in the latex composition.
